(19) United States
(12) Patent Application Publication
(10) Pub. No.: US 2014/0372250 A1
(43) Pub. Date: Dec. 18, 2014

(54) SYSTEM AND METHOD FOR PROVIDING RECOMMENDED CONTENT

(71) Applicant: FORBES MEDIA LLC, New York, NY (US)

(72) Inventor: Michael Dugan, New York, NY (US)

(21) Appl. No.: 13/920,622

(22) Filed: Jun. 18, 2013

(51) Int. Cl. G06Q 30/06

(52) U.S. Cl. CPC G06Q 30/0631
USPC 705/26.7

(57) ABSTRACT

A system and method for providing recommended content to a user. The method includes providing a Web server and receiving each of the inbound request messages from one of the Web browsers in the Web server. Selected data contained in each of the inbound request messages is recorded in a profile and associated with a user ID. The profile data includes information about entities that are related to the content accessed by each user. The method also includes analysis of a particular user's profile to identify the user's interests, identify similar users and idcntify recommended content based on the user's interests and look-a-like user interests. The method also includes automatically providing the user with access to recommended content for example, through a dashboard or window including links to the recommended content.

### CROSS-REFERENCE TO RELATED APPLICATIONS

The present application is related to and includes U.S. patent application Ser. No. 13/041,037, filed Mar. 4, 2011, which is hereby incorporated by reference as if set forth in its entirety herein.

### FIELD OF THE INVENTION

This invention relates to data communications systems and, more particularly, to methods and apparatus for providing targeted content according to transaction data associated with one or more users.

### BACKGROUND OF THE INVENTION

The World-Wide Web is based upon the Hyper Text Transfer Protocol (“HTTP”), which allows a user to quickly and easily access any number of servers attached to the Internet and to quickly and easily jump from one location to another. The locations may be on the same information server that a user is currently “visiting” or may be on an information server located half way around the world. This “Web” of information servers represents a vast store of easily accessible information.

For a variety of reasons, it is frequently desirable to record and evaluate the large number of information requests and responses handled by the Web server(s) at a given Web site. For this reason, conventional Web servers normally include a mechanism for compiling a log file which records information on every received HTTP request, including the domain name of the remote host making the request, an identification of the remote user, the date and time of the request, the request line exactly as received, the status code returned to the client, and the length of the response returned. In order to identify the aforesaid remote user, Web servers place identification tags, such as COOKIE and LSO's on the user's computer typically the first time they visit the Web Server. Upon subsequent visits by the user to the Web server, the aforesaid Cookie and/or LSO is sent in the HTTP request which the Web server uses to identify the user to preferably enable value added services (e.g., provide targeted content and/or advertising).

The volume and variety of content that is available for consumption on the world-wide-web is vast. This amount of content even on a single website may be described as a paradox of choice, where the excess of choices causes a viewer's inability to choose. As such, it is desirable for content providers to intelligently aid the user in narrowing the excess of choice by delivering content of interest to the user thereby maintaining the user's engagement and also providing an enhanced user experience.

To this end what is needed is a system to utilize the information gathered about a user to identify the user's interests, analyze available content and provide the user with content that is relevant to the user's interests.

### SUMMARY OF THE INVENTION

### BRIEF DESCRIPTION OF THE DRAWINGS

The objects and features of the invention can be understood with reference to the following detailed description of certain embodiments of the invention taken together in conjunction with the accompanying drawings in which:

FIG. 1 is a block diagram of a computer system that can be used with certain embodiments of the invention;

FIG. 1A is a block diagram illustrating an exemplary configuration of a computer executable program in accordance with certain embodiments of the invention;

FIG. 2 is a system level diagram of certain embodiments of the invention;

FIG. 3 is a flow diagram of certain embodiments of the invention;

FIG. 4 illustrates a user profile stored in the database of FIG. 2;

FIG. 5 depicts a web page having personalized content created using stored user profile information;

FIG. 6 depicts a flow diagram of certain embodiments of the invention.

### WRITTEN DESCRIPTION OF CERTAIN EMBODIMENTS OF THE INVENTION

The present invention is now described more fully with reference to the accompanying drawings, in which an illustrated embodiment of the invention is shown. The invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting the invention, but rather are provided as a representative embodiment for teaching one skilled in the art one or more ways to implement the invention. Furthermore, the terms and phrases used herein are not intended to be limiting, but rather are to provide an understandable description of the invention.

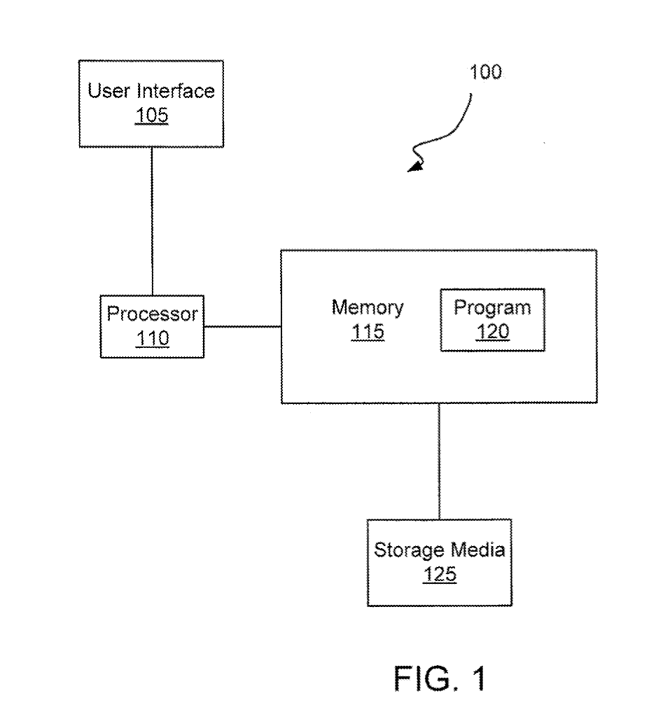

It is to be appreciated that the embodiments of this invention as discussed below may be incorporated as a software algorithm, program or code residing in firmware and/or on computer useable medium (including software modules and browser plug-ins) having control logic for enabling execution on a computer system having a computer processor. Such a computer system typically includes memory storage configured to provide output from execution of the computer algorithm or program. An exemplary computer system is shown as a block diagram in FIG. 1 depicting computer system 100. Although system 100 is represented herein as a standalone system, it is not limited to such, but instead can be coupled to other computer systems via a network (not shown) or encompass other embodiments as mentioned below. System 100 preferably includes a user interface 105, a processor 110 (such as a digital data processor), and a memory 115. Memory 115 is a memory for storing data and instructions suitable for controlling the operation of processor 110. An implementation of memory 115 can include a random access memory (RAM), a hard drive and a read only memory (ROM), or any of these components. One of the components stored in memory 115 is a program 120.

Program 120 includes instructions for controlling processor 110. Program 120 may be implemented as a single module or as a plurality of modules that operate in cooperation with one another. Program 120 is contemplated as representing a software embodiment of the process 300 described hereinbelow.

User interface 105 includes an input device, such as a keyboard, touch screen, tablet, or speech recognition subsystem, for enabling a user to communicate information and command selections to processor 110. User interface 105 also includes an output device such as a display or a printer. In the case of a touch screen, the input and output functions are provided by the same structure. A cursor control such as a mouse, track-ball, or joy stick, allows the user to manipulate a cursor on the display for communicating additional information and command selections to processor 110. In embodiments of the present invention, the program 120 can execute entirely without user input or other commands based on programmatic or automated access to a data signal flow through other systems that may or may not require a user interface for other reasons.

While program 120 is indicated as already loaded into memory 115, it may be configured on a storage media 125 for subsequent loading into memory 115. Storage media 125 can be any conventional storage media such as a magnetic tape, an optical storage media, a compact disc, or a floppy disc. Alternatively, storage media 125 can be a random access memory, or other type of electronic storage, located on a remote storage system, such as a server that delivers the program 120 for installation and launch on a user device.

It is to be understood that the invention is not to be limited to such a computer system 100 as depicted in FIG. 1 but rather may be implemented on a general purpose microcomputer incorporating certain components of system 100, such as one of the members of the Sun® Microsystems family of computer systems, one of the members of the IBM® Personal Computer family, one of the members of the Apple® Computer family, or a myriad of other computer processor driven systems, including a: workstations, desktop computers, laptop computers, netbook computers, a personal digital assistant (PDA), or a smart phone or other like handheld devices.

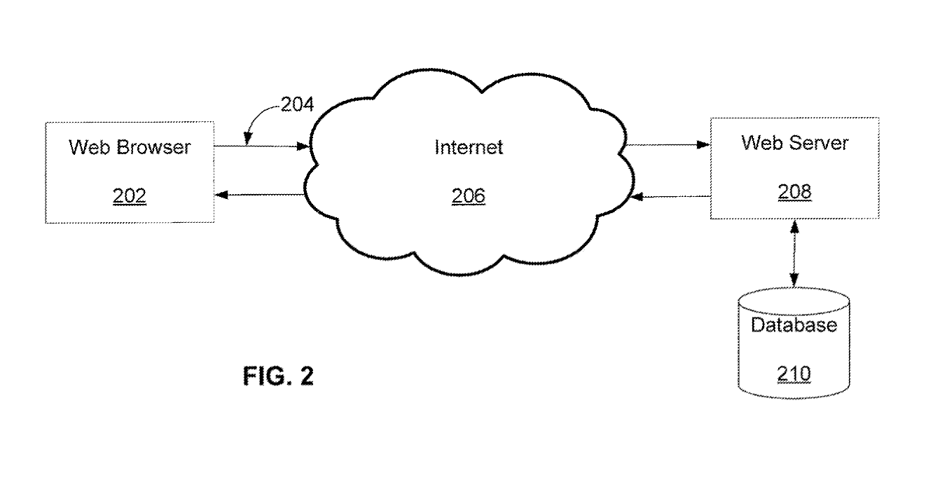

The method described herein has been indicated in connection with a flow diagram (FIG. 3) for facilitating a description of the principal processes of an illustrated embodiment of the invention; however, certain blocks can be invoked in an arbitrary order, such as when the events drive the program flow such as in an object-oriented program. Accordingly, the flow diagram is to be understood as an example flow and that the blocks can be invoked in a different order than as illustrated.

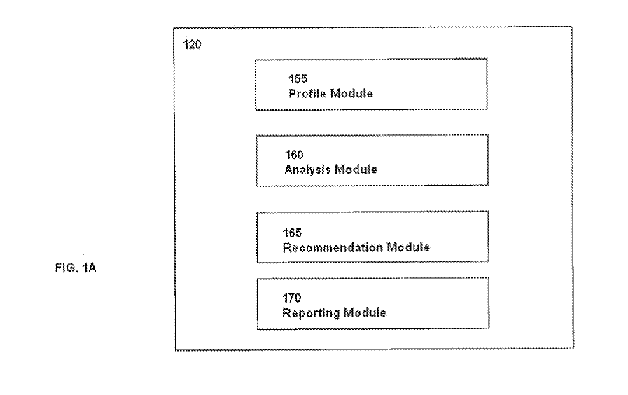

More particularly, illustrated in FIG. 2 is an environment of use for certain embodiments of the invention including Web browsers 202 from which request messages are received, and one or more Web server systems 208 which process those requests and return responses. A “browser” as that term is used here refers to any kind of user agent which sends HTTP request messages to and receives response messages from an HTTP server, and includes browsers, editors, spiders (web-traversing robots), or other end user tools. The term “server” and “Web server” as used herein means an application program that accepts connections in order to service HTTP request messages by sending back response messages. It is also to be understood to be used in conjunction with a Java server and a Hypertext Processor (PHP). The Java server is preferably operable to control the content or appearance of Web pages through the use of servlets which are small programs that are specified in the Web page and run on the Web server to modify the Web page before it is sent to the user who requested it. The PHP server generally creates dynamic web pages.

It is to be appreciated that virtually every device (e.g., Web browser 202) connected to the Internet 206 is assigned a unique number known as an Internet Protocol (IP) address. IP addresses consist of four numbers separated by periods (also called a ‘dotted-quad’), an example of which is: 157.12.5.6. Since these numbers are usually assigned to internet service providers within region-based blocks, an IP address can often be used to identify the region and/or country from which a computer is connecting to the Internet as well as other geographic information. An IP address may be used to show the user's general location. Additionally, virtually every web browser 202 includes a “UserAgent” which typically identifies itself, its application type, operating system, software vendor, or software revision, by submitting a characteristic identification string to its operating peer (e.g., Web server system 208). In the HTTP protocols, this is transmitted in a “User-Agent” header field.

With reference to FIG. 2, a generalized message flow for a single request/response exchange will now be briefly discussed. A remotely located Web browser 202 (for example, a Microsoft Internet Explorer executing on a PC connected to the Internet) transmits an inbound HTTP request message 204, via the Internet 206, to the Web server system 208. The Web server system 208 also stores information about the request message, and particularly the user of Web browser 202, in a database 210. It is to be appreciated that database 210 is preferably implemented by a relational database system, the functionality of which will be discussed further below. The Web server system 208 processes the request message and returns a response via the Internet 206 to the Web browser 204, preferably using profile information relating to the user of Web browser 202 as retrieved from database 210, as also discussed further below.

The Web server system 208 processes request and response messages which are received and sent using the Hypertext Transfer Protocol (HTTP), an application-level protocol used by the World-Wide Web global information system. The HTTP protocol is a request/response protocol. A client sends a request to the server in the form of a request method, URI, and protocol version, followed by a MIME-like message containing request modifiers, client information, and possible body content over a connection with a server. The server typically responds with a status line, including the message's protocol version and a success or error code, followed by a MIME-like message containing server information, entity meta-information, and possible entity-body content. HTTP messages consist of requests from client to server and responses from server to client.

The functions performed by the Web server system 208 for recognizing the user of a Web browser 202 during a request/response exchange are illustrated in the flow diagram of FIG. 3. It is to be understood the Web server system 208 receives an inbound HTTP request message 204 from Web browser 202. Based upon the inbound HTTP request message 204, a determination is made as to whether the Web browser 202 has a Flash media player installed (step 302). A Flash media player is understood to store Local Shared Objects (LSO's). An LSO, also commonly called flash cookies, are collections of cookie-like data stored as a file on a user's computer used by web sites to collect information on how people navigate web sites.

If it is determined a Flash player is installed, a determination is made as to whether the Flash player accepts LSO's (step 304). If yes, a determination is made as to whether an LSO is present which was previously provided by Web server system 208 (step 306). If no, then Web server system 208 creates and places an LSO in the Flash player associated with Web browser 202 so as to identify the user of Web browser 202 next time the user visits Web server 208 (step 308), as further discussed below. If yes (an LSO for Web server system 208 is present in the Flash player of Web browser 202 (step 306)), the inbound HTTP request message 204 is sent to a PHP server (step 310) and then to a Java server (step 312).

Returning to steps 302 and 304, if the requesting Web browser 202 was determined not to have a Flash player (step 302), or the Flash player was determined not to accept LSO's (step 304), then the inbound HTTP request message 204 from Web browser 202 is sent to the aforementioned PHP server (step 314). Afterwards, a determination is made as to whether a Cookie from web server 208 is present in the inbound HTTP request message 204 (step 316). As is known, a Cookie (also known as a: tracking cookie, browser cookie, and HTTP cookie) is a small piece of text stored on a user's computer by a web browser. The Cookie is sent as an HTTP header by a Web server to a Web browser and then sent back unchanged by the browser each time it accesses that server. A Cookie can be used for authentication, session tracking (state maintenance), storing site preferences, shopping cart contents, the identifier for a server-based session, or anything else that can be accomplished through storing textual data. It is to be appreciated most Web browsers allow users to decide whether to accept Cookies, and the time frame to keep them.

If a Cookie was determined not to be present in the inbound HTTP request message 204 (step 316), a Cookie is then caused to be placed in the user's Web browser 202 (step 317) after which the Cookie is then verified (step 320). The inbound HTTP request message 204 is then sent to the aforementioned Java server (step 312).

It is to be appreciated that the aforesaid steps for determining whether an aforesaid LSO or Cookie was present in the inbound HTTP request message 204 are performed in JavaScript and/or ActionScript on the client-side (e.g., the user's Web browser 202). Additionally, it is to be appreciated that when the user's “ID” is generated, (e.g., the LSO or Cookie, as mentioned above), it is preferably generated by a call to the PHP platform.

With continuing reference to FIG. 3, on the server-side (e.g., Web server 208) for the inbound HTTP request message 204, a determination is then made as to whether the inbound HTTP request message 204 contained a user ID (e.g., a LSO or Cookie) (step 315). If there was no user ID, then a “hash ID” is to be used for the inbound HTTP request message 204 preferably consisting of the IP address and UserAgent associated with the inbound HTTP request message 204. A determination is then made as to whether the user (as identified by the aforesaid hash ID) for inbound HTTP request message 204 resides behind a firewall (step 318). This determination is made by determining if an IP address of hash ID is associated with other previously recognized hash ID's which have the same IP address. This is indicative of a firewall because all user's of a firewall are typically assigned a common IP address. If yes, the process ends because the user of the inbound HTTP request message 204 cannot be accurately tracked due to the presence of a firewall and the lack of a user ID (e.g., LSO or Cookie). If there was no determined firewall (step 318), then a determination is made as to whether the user (as identified by its hash ID) of the inbound HTTP request message 204 is an existing user (e.g., previously accessed Web server 208) (step 322). If it is determined the user of the inbound HTTP request message 204 is a new user (the user hash ID was not previously recorded in database 210), then a new profile record for the user is created in the database 210 (step 324), as mentioned further below. And if it is determined the user of the inbound HTTP request message 204 is an existing user, then the user's preexisting profile record is accordingly updated (step 326), as also mentioned further below.

Returning reference now to step 314 in FIG. 3, if it is determined the inbound HTTP request message 204 contained a user ID (e.g., a LSO or Cookie), then a determination is made as to whether the user (as identified by the User ID) of the inbound HTTP request message 204 is an existing user (e.g., previously accessed Web server 208) (step 328). If the aforesaid User ID is not recognized, this could be indicative that the user is either new or recently cleared their LSO's and/or Cookies, or is using a new web browser or changed their privacy settings to now allow LSO's and/or Cookies. Regardless of the reason, if the User ID is not recognized (step 328), a determination is made as to whether the user uses a firewall (step 330). This is accomplished by determining if the IP address of the inbound HTTP request message 204 was associated with other previously received inbound HTTP request messages having a common IP address but different hash ID. If yes, the IP address was previously recognized, this is indicative the user of the inbound HTTP request message 204 is a new user who uses a firewall. A new profile record for the user is then created in the profile database 210 (step 324), as mentioned further below. If no, the IP address was not previously recognized with the user's inbound HTTP request message 204 (step 321), then a determination is made as to whether the user (as identified by it's hash ID) is an existing user who previously accessed Web server 208 (step 322) (e.g., has the user's hash ID been previously recognized). If it is determined the user of the inbound HTTP request message 204 is a new user (e.g., first time accessing Web server 208), then a new profile record for the user is created in the profile database 210 (step 324), as mentioned further below, And if it is determined the user of the inbound HTTP request message 204 is an existing user (e.g., previously accessed Web server 208), then user's preexisting profile record is accordingly updated (step 326), as also mentioned further below.

Returning reference now to step 328 in FIG. 3, if the aforesaid User ID is recognized as having previously accessed Web server 208, a determination is made as to whether the IP address of User ID has been previously recognized with other User ID's (step 332). If yes, that is the IP address has been used in conjunction with different User ID's, this is indicative that the User uses a firewall and the User ID is flagged as a firewall user (step 334).

Next, a determination is made as to whether the User ID for the inbound HTTP request message 204 has been used in conjunction with other IP addresses (step 336). In other words, has different IP addresses been used in conjunction with the User ID, which is indicative that the User is a “roamer” (e.g., the user uses a laptop from multiple locations, such an office, home or travel location each having a unique IP address). If yes, the User ID is flagged as a “roamer” (step 338).

Next, a determination is made as to whether the hash ID associated with the inbound HTTP request message 204 has been previously associated with the aforesaid User ID (step 340). If no, then this is indicative that the user has changed or upgraded their web browser since their UserAgent has changed and the user's hash ID is then tagged to reflect this web browser change (step 342) which is then recorded in it's profile record in database 210 (step 344). If yes, (the user's hash ID matches it's previously used hash ID) then the user's activity via the inbound HTTP request message 204 is recorded in it's profile record in database 210 (step 344).

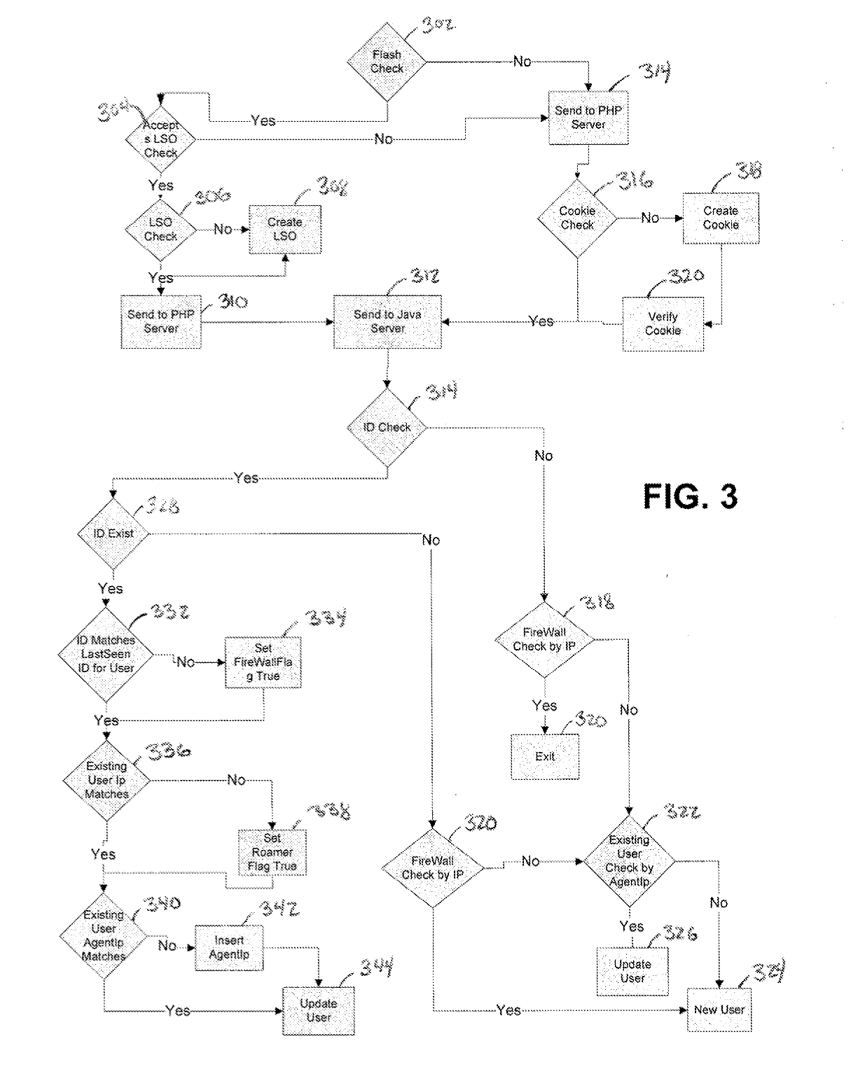

With reference now to FIG. 4, the aforesaid process 300 for recognizing a user 402 of an inbound HTTP request message 204 is used to create (e.g., a new user) or update (e.g., an existing user) a profile record 400 for the user 402 in database 210. As mentioned above, information to be recorded in the user's profile record in database 210 includes whether the user is a new user (step 324), an existing user (steps 326 or 344), uses a firewall (steps 318, 330 or 334), is a roamer (338), and has changed their web browser (step 342). Additionally, as depicted in FIG. 4, each user's profile record 400 in database 210 will preferably include content metadata fields 410, referring data sources 412, 414 and 416, user geographic data 418 and system identification information 420 relating to the user 402. This information is preferably obtained from analysis of the user's inbound HTTP request message 204.

It is to be appreciated that an advantage of the certain illustrated embodiments of the invention is the aforesaid collected data in each user's profile record created in database 210 aggregates raw traffic logs into a normalized database enabling reporting user trends and for providing user segmentation that classifies user's into sales groups and interest categories, geographic sectors and loyalty tiers as further described herein. These classifications are then developed as business rules and made available for ad targeting and content personalization as further described herein.

While the foregoing describes exemplary methods of recognizing a user from an HTTP request and generating a profile for the user. The invention is not limited to the illustrated embodiments for identifying a user, which can be embodied in various forms, as appreciated by one skilled in the art. For example, alternatively or in addition, a user ID can be obtained from a variety of identification tags, such as a COOKIE and/or LSO's such as those Cookies issued through the WordPress application by WordPress Org.

Building upon the exemplary user identification, data collection and profile generation systems and methods described in relation to FIGS. 1-5, the systems and methods further described herein facilitate: collecting information relating to a user's activity on a website, this information includes the user's browsing history, what content is accessed, what the content relates to, when the content was accessed and the like; storing and maintaining the user information as a user profile in a database; analyzing the user profiles and/or content to identify interests, user trends and the like; analyzing user profiles for clustering and segmentation purposes. Based on the identified user interests, habits and the population of similar users, content that is relevant to the user is selected and provided to the user as personalized recommendations. For example, through a dashboard or window including links to recommended content Accordingly, the user is provided with an enhanced user experience, and the website experiences increased user engagement.

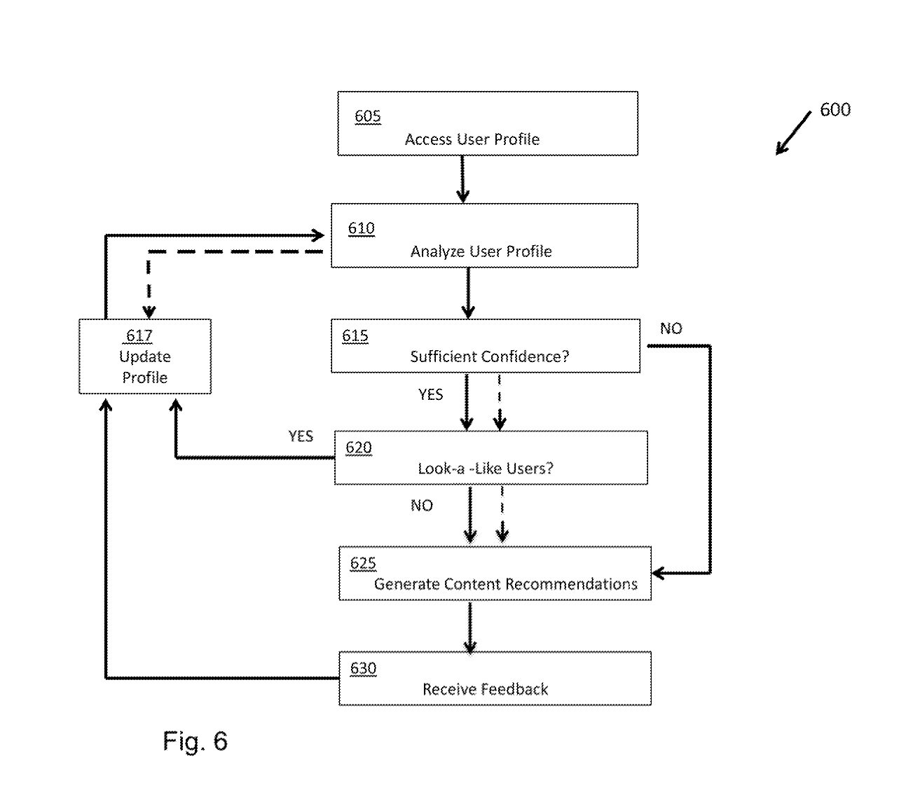

Turning now to FIG. 6, and in reference to the exemplary user profile 400 depicted in FIG. 4, a flow diagram illustrates a routine 600 for facilitating the recommendation of related content in accordance with at least one embodiment disclosed herein. It should be appreciated that more or fewer operations can be performed than shown in the figures and described herein. In some implementations, the routine 600 can be performed by a processor executing instructions stored in a computer-readable storage medium, for example, a processor residing in the web server 208 of FIG. 2 and/or other operatively connected computing devices (hereinafter individually and/or collectively referred to as “server”). The executed instructions can include one or more modules, including, preferably, a profile module 155, an analysis module 160, a recommendation module 165 and a reporting module 170, as depicted in FIG. 1A.

By way of general overview, the profile module 155 stores and maintains the various pieces of information relating to a user's browsing history in a user profile 400. Of particular importance to ultimately recommending content is the history of the content consumed by the particular user and the “entities” that are referenced in content consumed. Entities include the author of the content, topics covered, people, places, and things reference in the content, and the like. Based on the user profile, the analysis module 160 identifies a particular user's interest in various entities listed in the profile. In addition, the analysis module can identify the particular user's habits and infer additional entities of interest, and user attributes (e.g., age, education, etc.). The analysis module also compares the particular user to other users in the population to identify and group similar users. Accordingly, interests and attributes that are yet to be positively revealed by the particular user through viewing content can be inferred from similar user profiles. To further improve recommendations, the analysis module calculates the level of the particular user's interest in each entity and weights the information in the profile according to how reliable and how current the data points are. Based on the user profile analysis, the recommendation module 170 identifies the content to recommend to the particular user. If the particular user does not have sufficient information in the profile for personalized recommendations, the content can be recommended according to a default, global popularity. Otherwise, the recommendation module identifies content that relates to the entities of interest to the particular user, habits and according to the relative interest levels and other variables calculated by the analysis module. In addition, the content recommendations are also generated according to the profiles of the similar users as the similar users are generally representative of the particular user. Content recommendations are ultimately transmitted to the user by the reporting module 170. The profile module, the analysis module, the reporting module and the content recommendation modules each receive feedback regarding a user's reaction to the recommendations in order to adjust parameters according to the feedback and improve recommendations.

Each of the modules are further described in greater detail below as generally noted by the headlines.

### A. User Profile Generation

The process begins at step 605, in which the processor executing one or more modules including, preferably, the profile module 155, receives an inbound HTTP request over a network from a web browser operated by a user 402. The processor executing the profile module is configured to recognize a user 402 from the inbound HTTP request message 204 and create (e.g., for a new user) or update (e.g., for an existing user) and access a profile record 400 associated with the user in database 210, such as in the manner described in process 300. It should be understood that users are identified or recognized in this manner as unique devices requesting pages, and not as particular humans, which would require further identifying information beyond the requirements of this invention.

As discussed in relation to FIG. 4, it should be understood that after the profile 400 has been generated, upon each successive page-view as the user continues to navigate content, the server receives and the processor executing the profile module processes successive inbound HTTP requests and continually records the activity of the user 402. In this manner the configured processor updates and/or generates real-time anonymous profiles for each user based upon for example, the content they consume, when they visit and from where they were referred by gathering metadata, timestamps and HTTP headers as they engage with web-pages.

The information gathered and stored by the configured processor (e.g., data points), can include referring data sources 412, 414 and 416, user geographic data 418 and system identification information 420 relating to the user 402. Such information collected and stored can be associated with a time-stamp of the request so as to date the information collected. Preferably, the data points also include information relating to the content (e.g., the web-page, article etc.) accessed by the user which can be stored as content metadata in the content metadata fields 410 of the user profile record 400. The content metadata identifies the content accessed by the user and identifies “entities” associated with the accessed content, including by way of example and without limitation, the author of the content, companies, people and/or places mentioned in the content, keywords, topic(s) to which the content is slotted (e.g., business or lifestyle or sports) and the like. Preferably, each entity has a unique and persistent “naturalId.”

For example, the content metadata can be stored in a tuple format “naturalId, URI, name” however, alternative naming conventions can be used. Table 1 is an exemplary list of entities associated with content accessed by user 402 (i.e., “fred”) and stored in user content metadata fields 410 of user profile 400. As shown in Table 1, the field(s) relating to the entity “College” has (have) a natural ID of College (organization) and the additional fields (URI and name) can be populated with the particular colleges that are covered in content accessed by user 402.

TABLE 1

| naturalID | URI | name |
|---|---|---|
| College | fred/college/27 | boston-college Boston |
| (Organization) | | College |
| Company | fred/company/668 | boston-properties Boston |
| (Organization) | | Properties |
| Team | fred/team/80041 | boston-celtics Boston |
| (Organization) | | Celtics |
| Person | fred/person/13198 | carla-bruni-sarkozy Carla |
| | | Bruni-Sarkozy |
| Topic | fred/lifestyle/channel_7 | Lifestyle |
| (Channel/Section) | | |
| Topic | fred/Arts & Entertainment/ | Arts & Entertainment |
| (Channel/Section) | section_94 | |
| Writer | fred/Kurt Badenhausen | Kurt Badenhausen |
| (Contributor) | Forbes Staff | |
| Place | fred/places/14484 | ma/boston Boston |

The processor configured by executing the profile module 155 can combine or associate one or more anonymous profiles that are later positively associated with a particular user. More specifically, in the event that the configured processor has generated multiple anonymous profiles (e.g., when the user anonymously accesses the website on one or more devices) and the processor thereafter receives user identification information (e.g. from the user actively logging into the website from the one or more devices), the processor can store the identification information in the user's profile either in combination or otherwise associated with each previously anonymous profile. As such, when the user is logged in with a member ID, the processor can build a unified profile irrespective of the device used by the user. To this end, the systems and methods of identifying users as described in reference to FIGS. 1-5, and the cookies such as the WordPress cookie, can be used by the configured processor to positively identify a particular user.

A.1 Analyzing Content to Identify Entities

It should be understood that the processor, configured by executing one or more modules including, preferably, the profile module 155, the analysis module 160 or the recommendation module 165 can analyze content to identify (e.g., harvest from the content) the entities associated therewith. This can be performed upon receipt of an HTTP request signaling the user's request to view a page (“user pageview”). Alternatively, or in addition, the server can harvest content metadata for the page, associate the metadata with a natural ID of the content (e.g., the content URI) and store it in a database prior to a user pageview. However, due to the real-time nature of content and the possibility of changing metadata associated with content after it has been published, it is preferable to harvest content metadata upon modification. For example, existing content can be further produced or updated, say, by a contributor adding to or commenting on an article using a Contributor Platform (CP) or, for instance, the WordPress Program. As such, the processor configured by executing the analysis module, can extract content metadata from content as it's produced. The extraction process performed by the processor at the time of publication can do basic pattern matching, and can be configured to provide metadata suggestions for the writer to accept. In addition, due to the real-time nature and possibility of changing metadata, it is preferable to record content metadata to the user profile 400 upon each pageview.

### B. User Profile Analysis

Then at step 610, the processor configured by executing one or more of software modules, including, preferably, the analysis module 160, analyzes the user profile 400 to identify the entities of interest to the user 125, calculate an interest level for each identified entity, and identify user habits and characteristics.

B.1 Identifying Entities of Interest and Calculating Interest Level

More specifically, the configured processor can access the content metadata 410 fields of the profile 400, which stores a record of the content that was accessed by the particular user, and for each particular piece of content includes a list of the entities associated therewith (e.g., the people, places, topics, etc. covered by the particular piece of content). The configured processor can cross-reference the metadata so as to identify entities that are common to multiple pieces of accessed content and calculate the user's interest level in each particular entity according to an algorithm that is a function of how frequently the particular user 102 accesses content that is associated with the particular entity.

B.2 Calculating Decay Factor

In addition, the processor configured by executing one or more of software modules, including, preferably, the analysis module 160, can assign a decay factor to each metadata entry in the user profile 400. The decay factor can be defined in terms of a duration and/or a decay rate that can be updated or varied. For example, when a particular entity is first stored in a content metadata field 410, the configured processor can associate a prescribed decay factor to the particular metadata entry. With each additional metadata entry occurrence that identifies the particular entity (e.g., due to continued user pageviews relating to the particular entity), the configured processor can re-calculate the decay factor such that the metadata entry decays at a slower rate and/or has a longer decay period. The configured processor can also calculate and assign the decay factor as a function of the frequency with which the particular entity is mentioned in content. As such, entities that are of interest to the user but are not frequently the subject of content will decay more slowly or have a longer duration.

It should be understood that the configured processor can similarly set a decay factor for the other data points in profile 400 (e.g., content, source, user, geographic data points and the like) or the profile as a whole. As such, the decay factors prevent data-points representative of user's passing interests from becoming permanently associated with the user and prevent outdated profiles from persisting in the database. As a result, the dataset of information is more relevant and manageable and the recommendations are more accurate because they are not being skewed by extraneous data.

B.3 Determining User Habits

The processor configured by executing one or more software modules including, preferably, the analysis module 160, can also analyze time-stamps associated with data points, preferably those associated with the metadata entries to identify patterns in the user's interests (e.g., entities identified in metadata), as a function of the day of the week or time that the user accesses content relating to a particular entity. Based on the identified interest patterns, the configured processor generate and store rules for generating recommendations according to the interest pattern in user profile 400. For example, if the user is identified as accessing content about a particular company on week days and is accessing content about a particular sports team on the weekends, the processor can record this interest pattern in the user profile 400 such that future content recommendations can be generated consistent with the interest patterns. Similarly, the configured processor can also identify user patterns as a function of the type of content (e.g., text, video, images etc.).

B.4 Determining a Confidence Level in a User Profile

Then at step 615, the processor executing one or more modules, including, preferably, the analysis module 160 and/or the recommendation module 165, determines whether the profile 400, has a sufficient confidence level to provide recommended content to the user. The confidence level reflects how reliable the profile is as an indicator of user's (402) and therefore the configured processor can assess the reliability of the current profile data as a basis for identifying recommended content for the user 402.

The configured processor can calculate the confidence level: for individual data-points in the profile; categories of information (e.g. user data fields, content metadata fields 410, source data 412); or the profile 400 as a whole. More specifically, the information stored in user profile 400 can be initially assigned a default confidence level; as the configured processor builds the profile according to continued user interaction the confidence level can be increased as a function of the number of data points in the profile. In addition or alternatively, the processor can re-calculate/adjust the confidence level as a function of the calculated interest levels in entities and/or the number of different entities of interest or the relatedness of interests. For example, a user profile that exhibits a high interest level in a number of various entities can be assigned a confidence level that is indicative of a reliable profile. Conversely, a shared computer associated with a high volume profile having a large number of low interest level entities that are generally unrelated to one another can be assigned a low confidence score, thereby avoiding inaccurately grouping the profile to similar profiles (“look-a-likes”). In addition, if through feedback (e.g., at step 630), the user profile 400 has been determined to be a good or poor metric for suggesting content the confidence score can be re-calculated accordingly.

B.5 Identifying “Look-a-Like” Users

Then at step 620, the processor executing one or more of modules, including, preferably, the analysis module 160 and/or the recommendation module 165, compares the user profile 400 to other user profiles stored in a database to identify look-a-like users and cluster the user 402 with the look-a-likes in real-time.

More specifically, if the processor has determined at step 315 that the user profile has a sufficient confidence level, the processor configured by executing the analysis module 165 identifies the look-a-likes by applying an algorithm that, for each of the comparison users (i.e., other stored user profiles), compares data-points from the user profile 400 to corresponding data-points in a particular comparison user's profile and filters out the dissimilar comparison users. The filtering can comprise a disqualification of certain users outside of a threshold range of matching criteria.

For example, the comparison users and the data-points that are compared can be selected as a function of the confidence level, the decay value and the interest levels associated with a data-point or any of the foregoing factors. For example, as a default, only profiles with high confidence scores are compared to create a cluster of look-a-like users.

The configured processor can determine whether a comparison user is a match by applying an algorithm which is a function of the number, percentage or frequency of common data points between profiles, the relative interest level in each data point, the importance of each data point (e.g., metadata has higher importance than geographic data points), decay or confidence associated with each data point. Whether a data point is a match can also be determined as a function of the specificity of the data point. For example, a specific entity of interest can be found to match if the comparison users share an interest in the same company. As a further example, when the processor determines a match as a function of decay, the user's (402) current and high interest level in a particular company can be determined to not match a comparison user's decaying interest in a particular company.

In addition, the server executing one or more of software modules, including, preferably, the analysis module 160, can rank each of the user profiles compared by a relevance factor which is calculated as a function of how closely particular data points match. The relevance factor can also be calculated on an overall basis.

The processor configured by executing modules including, preferably, the analysis module 160, can identify the look-a-like comparison users and add/associate the look-a-likes to the cluster iteratively until all are identified. Alternatively the system can iterate until at least a desired number of look-a-likes are identified or until a desired number having a relevance factor that is above a pre-determined threshold is reached. If the cluster does not include the desired number of look-a-likes, the configured processor can repeat the process of identifying look-a-likes by selectively relaxing the standards such as decay, interest level, confidence or the standards used to compare users until the desired number of “look-a-like” users are identified. Thus, the threshold can be lowered or raised, as appropriate, or a range for comparison widened to fit the algorithm to a solution having the desired or prescribed number of look-a-like users. Similarly, the configured processor can also compare specific data points on a higher level of abstraction, for example, categorizing specific company entities into a broader “business” category for comparison purposes.

Furthermore, it should be understood that, in the event that one or more data-points from profile are not found in a comparison user, the configured processor can adjust or discount the relevance factor associated with the data-point or profile as a result. As such, the algorithm again can be adjusted to fit a desired or prescribed solution.

It should be understood that defined clusters can be stored and associated with other related clusters, for example, hierarchically from broadly defined clusters to narrowly defined clusters. Accordingly, instead of the processor being configured to compare the user profile 400 to each other user in the database, the user profile 400 can be compared to common data points in broadly defined clusters before being matched to more narrowly defined clusters. Accordingly, new user profiles or changing profiles can be quickly associated with previously defined clusters without completely re-defining the clusters each time. Feedback from providing content recommendations can be received by the configured processor (e.g., at step 630) and used to determine whether content recommendations generated according to the cluster is positively received by users. As such, the profiles as well as the process for identifying and defining clusters can be adjusted in real time.

B.6 Updating the User Profile

Then at step 617, the processor configured by executing one or more of software modules, including, preferably, the analysis module 160, can apply categorization rules to the user profile 400 in order to determine if the profile data corresponds to one or more attributes, say, age, education, occupation, or interests to a sufficient degree and the results can be stored to the user profile. Various methods and rules for categorizing a user based on interests, habits and the like exist as will be understood by those skilled in the art. Attributes can also be actively provided by user 402, say, during a log-in or registration process. In addition, the processor can be configured to infer attributes from look-a-like users and the result can be stored to the user profile 400. As discussed above, the configured processor can also calculate and assign a confidence level to any of the inferred attributes so as to differentiate between attributes according to reliability. As an example, attributes can be gauged as more reliable if received through user's direct input whereas inferred attributes can be gauged as less reliable.

### C. Generating Content Recommendations

Then at step 620, the processor configured by executing one or more modules, including, preferably, the analysis module 160 and/or the recommendation module 165 can identify recommended content to provide to the user 402.

C.2 Generating Content Recommendations According to the Confidence Score

The processor configured by executing instructions in the form of modules, including, preferably, the recommendation module 165, can generate content recommendations as a function of the confidence level associated with the user profile 400. If the confidence level does not exceed a threshold level, the processor executing the recommendation module provides, as a default, the most popular content currently available. For example, the configured processor can default to recommending content that is most popular across the entire population and/or content that relates to the most popular entities (e.g., the most popular or trending articles or entities). After the threshold confidence level is reached, and as the confidence level for the user profile 400 increases, the configured processor can selectively adjust the parameters (e.g., make more stringent or relaxed) for determining the likelihood a piece of content will be of interest to the particular user thereby providing content that is tailored to the user's interests as a function of how reliable the data points in the profile are.

In order to identify recommended content after the user profile confidence level exceeds the threshold, the configured processor can select content of predicted interest to the user 402; rank the selected content according to a calculated likelihood that the user 402 will access the identified content, and identify recommended content (e.g. generate recommendations) according to such rankings.

C.1 Calculating the Likelihood Score for Available Content

More specifically, the configured processor can first compare a list of currently available content to the record of content already accessed by the user 402 and stored in the profile 400 as content metadata, and identify a subset of content that is currently available and not yet accessed. For each piece of content in the subset, the processor executing the recommendation module 165 can apply an algorithm that calculates the user's interest in the content as a function of the user profile 400, including by way example and without limitation, entities of interest, associated interest levels, decay value, attributes and user habits identified at step 610 and/or according to the profiles of one or more look-a-like users identified at step 615.

The configured processor can cross-reference user profile 400 to a database listing entities associated with each piece of content in the subset to identify content that is relevant to data points in the user profile 400. For example, the metadata identifying entities of interest to the user and stored in the user profile can be compared to a list of entities related to a particular piece of content. It should also be understood that the systems and methods for comparing the user profile 400 to other users' profiles, as discussed in relation to Step 605, 610 and 615, can be employed by the processor to determine whether a particular piece of content is relevant to user's interest. In addition, as discussed in relation to Steps 605, 610 and 615, the configured processor can also calculate a relevance score for each piece of content as a function of the user's interest level in the entities, decay factor, confidence level, user's habits, as well as a function of the type of content and the news-cycle of the entities or a combination of the foregoing. It should be understood that a content's relevance score can also be considered to be a “likelihood” score which is indicative of the likelihood (or prediction) that user will access the content if it is recommended.

In a similar manner as described above, the configured processor can also identify relevant content for one or more look-a-like users and calculate the relevance and likelihood score for the content according to the user's similarity to the look-a-like user(s). For example, even if the user profile 400 does not support a determination that the user is interested in a particular entity, the processor can infer that the user 402 might be interested in content relating to the particular entity based on look-a-like interest in the particular entity.

In addition, the processor configured by executing the analysis module 160 and/or the recommendation module 165, can calculate the likelihood score for a particular piece of content as a function of the browsing history of one or more look-a-like consumers. The likelihood can be calculated as a function of the similarity in the look-a-likes browsing histories to the user's 402 browsing history; the overall relevance of the look-a-likes to the user; and the user's and look-a-like's relative interest in the entities covered by the particular content. For example, if the configured processor identifies that the user 402 and the look-a-likes having a high overall relevance view a first piece of content and that a significant number of the look-a-likes also view the particular content, the processor can be interpret such look-a-like behavior to be indicative that the user will likely be interested in the content and the processor can calculate a likelihood score accordingly. By way of further example, when the first piece of content and the particular content relate to a common entity, and the user and the look-a-like share a high interest in the common entity, the processor can interpret this as an even higher likelihood that the user 402 will be interested in the content and the processor can calculate the likelihood score accordingly.

Moreover, the configured processor can calculate the likelihood that the user 402 will access the particular content as a function of feedback obtained from the user's interaction with previous recommendations (e.g., received at step 630). Similarly, feedback obtained from look-a-like user responses to the same or similar recommendations can also be used in the same manner. For example, the configured processor can analyze feedback to determine whether look-a-likes frequently view a particular piece of content when it is recommended and calculate likelihood score accordingly. It should be understood that user feedback, look-a-like feedback as well as feedback across the entire user population can be analyzed by the configured processor so as to automatically adapt the methods of identifying content, calculating likelihood score and also inferring attributes between users.

C3. Ranking Content

In addition, the processor executing instructions in the form of one or more modules, including, preferably, the analysis module 160 and/or the recommendation module 165 can rank the content in the subset of available content according to the calculated likelihood score. Furthermore, the configured processor can also identify/select a more limited selection of recommended content to be provided to the user 402 according to the likelihood score and/or according to a variety of different categorization strategies. For example, the configured processor can select the five highest ranked pieces of content. By way of further example, the processor can categorize the rankings by, say, topic (e.g., business, leisure, sports) and randomly select one of the top five highest ranked content for each such topic. In addition, even after a user profile has reached a certain confidence level, the content or entities that are popular with the user population in general at the time can be layered in with the recommendations generated to provide the user with content that the broader user groups and/or the entire user population is consuming.

In order to recommend content and determine popularity and relevance in a way that isn't self-propagating (e.g., artificially inflating popularity through recommendations) the processor configured by executing one or more modules including, preferably, the recommendation module 165 and/or the reporting module 170, can selectively randomize the content recommendations to provide to at least a sample set of users. Furthermore, the configured processor can receive the user interaction with the randomized suggestions (e.g., at step 630) and analyze the feedback to determine the true popularity for the larger clusters or entire population of users.

Then, at step 625, the processor configured by executing one or more modules, including, preferably, the reporting module 170, provides the recommended content identified at step 615 to the user 402 via the computing device operated by the user and connected to the server over a network. Content recommendations can be transmitted to user 402 through various products on the website, for example, recommended headlines, a follow bar, tickers, e-mail digests, a personal homepage for user 402 on the website, product promotions as would be understood by those skilled in the art.

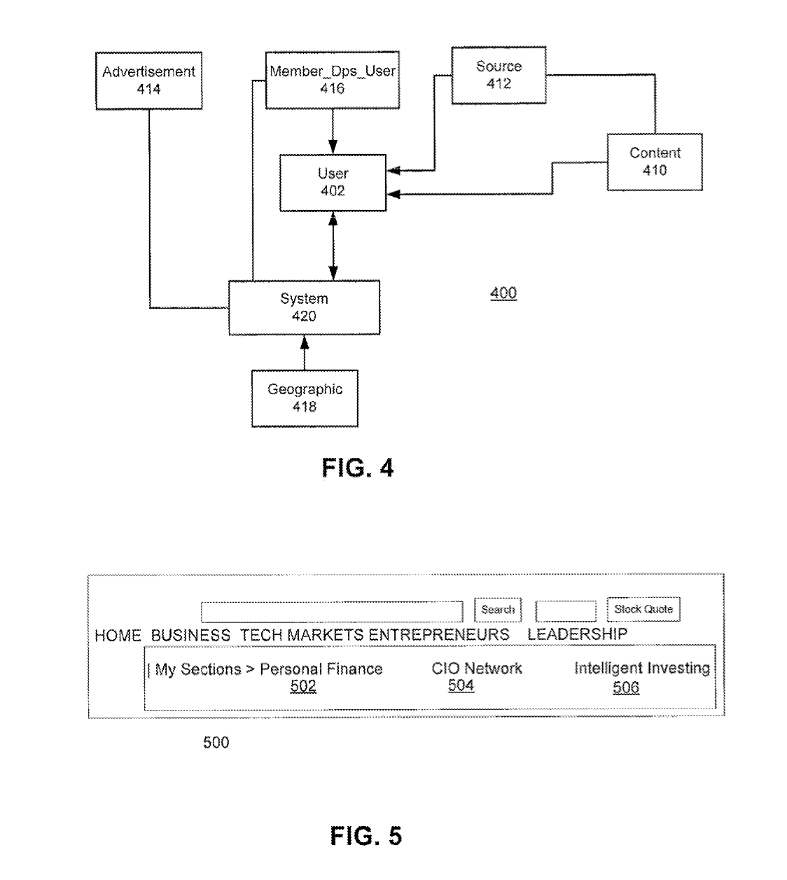

For instance, with reference to FIG. 5, the aforesaid user data collected in database 210 can be used to provide a customized floating personal navigator toolbar 500 indicating areas 502-506 that are determined to be the content of highest interest to user. It can also indicate areas that the user will likely visit based on the user's recorded viewing profile as set forth in database 210.

Then, at step 630, the processor configured by executing one or more modules, including, preferably, the analysis module 160 and/or the profile module 165, receives feedback from the user 402. Feedback is received in the form of a subsequent inbound HTTP request message from the computing device operated by the user. The configured processor can analyze feedback by comparing the inbound HTTP request to determine whether the request corresponds to one of the pieces of content provided as recommended content at step 625. It should be understood that feedback can be used to adjust the parameters for analyzing the user profile, updating the user profile, and identifying recommended content, as discussed in reference to steps 605-625.

Optional embodiments of the invention can be understood as including the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention have been described, it should be understood that various changes, substitutions, and alterations can be made by one of ordinary skill in the art without departing from the scope of the present invention.

What is claimed is:

1. A computer implemented method for providing recommended content responsive to inbound HTTP request messages sent to a server from remotely located computing devices via a network, the server including a processor and a storage medium storing user profiles, each of the user profiles being associated with one or more of the computing devices and having a confidence level and data-points including content metadata identifying one or more pieces of content accessed by the associated computing device and identifying one or more entities associated with the one or more pieces of accessed content, the method comprising:
receiving, using the processor configured by executing instructions in the form of one or more modules, a first inbound request message from a first computing device;
accessing, using the configured processor based on the first inbound request message, a first user profile associated with the first computing device;
determining, using the configured processor, whether the first user profile confidence level exceeds a threshold level;
if the first user profile confidence level does not exceed the threshold level,
(a) identifying, using the configured processor, recommended content from a database of available content, wherein, identifying recommended content includes executing an algorithm that selects recommended content according to a rank calculated for each piece of available content as a function of popularity, otherwise,
(b) defining, using the configured processor, a cluster of look-a-like user profiles by applying an algorithm that, for each of a plurality of comparison user profiles selected from the database of user profiles, compares the first user profile to a particular comparison user profile and adds the particular comparison user profile to the cluster when a match is determined, and
(c) identifying, using the configured processor, recommended content from a database of available content, wherein, identifying recommended content includes executing an algorithm that selects recommended content according to a rank calculated for each piece of available content as a function of the first user profile data points;
updating the first user profile, using the configured processor, according to the cluster of look-a-like user profiles, wherein updating includes adding one or more data points shared by one or more of the look-a-like user profiles in the cluster to the first user profile, wherein the one or more data points are user attributes including one or more of: age, education, occupation, and interest in one or more entities;
providing, using the configured processor, the recommended content to the first computing device over the network, wherein the recommended content includes one or more pieces of available content that is selected as a function of the calculated rank;
receiving, by the configured processor, feedback in the form of a subsequent inbound HTTP request message from the first computing device; and
updating, using the configured processor, the first user profile as a function of the feedback.

2. A method as recited in claim 1, further including the steps of:
extracting, using the configured processor, a UserAgent and IP address associated with the first inbound request message;
generating, using the configured processor, a hash from the extracted UserAgent and IP address to uniquely identify the user associated with the first inbound request message; and
associating, using the configured processor, the generated hash with the first user profile and storing said generated hash in said database with the first user profile.

3. A method as recited in claim 2 wherein the step of extracting includes extracting a Cookie from said first inbound request message to augment said generated hash to uniquely identify the user associated with said first inbound request message.

4. A method as recited in claim 2 wherein the step of extracting includes extracting a Flash Local Stored Object (LSO) from said first inbound request message to augment said generated hash to uniquely identify the user associated with said inbound request message.

5. A method as recited in claim 1, wherein each of the plurality of profiles and each of the data points in the plurality of profiles includes a decay factor.

6. A method as recited in claim 1, wherein in the step of defining the cluster, the particular comparison user is selected from the plurality of user profiles according to an algorithm which is a function of the confidence level associated with the particular comparison user.

7. A method as recited in claim 1 further including the steps of:
extracting, using the configured processor, additional data points including content metadata from the first inbound request message;
storing, using the configured processor, the additional data points in the first user profile; and
calculating, using the configured processor, the first user profile confidence level, wherein the confidence level is calculated as a function of the number of data points stored in the first user profile and storing the calculated confidence level to the first user profile.

8. A method as recited in claim 1 further including the steps of:
calculating, for each of the one or more entities identified in the content metadata stored in the first user profile, the first user's interest level in a particular entity by applying an algorithm that is a function of a frequency that the particular entity is associated with the one or more pieces of accessed content; and
storing the calculated interest level in the first user profile,

9. A method as recited in claim 1 further including the steps of:
calculating, for each of the one or more entities identified in the content metadata stored in the first user profile, the first user's interest level in a particular entity by executing an algorithm that is a function of a frequency that the particular entity is identified in the content metadata; and
storing the calculated interest level in the first user profile,

10. A method as recited in claim 1, wherein the step of identifying recommended content includes:
calculating the rank for the particular piece of content as a function of an interest level associated with one or more entities identified in metadata, if the one or more entities identified in metadata are also associated with the particular piece of content.

11. A method as recited in claim 1, wherein the step of identifying recommended content includes:
calculating the rank for the particular piece of content as a function of data points from one or more look-a-like user profiles in the cluster of look-a-like user profiles.
